(19) United States
(12) Patent Application Publication
(10) Pub. No.: US 2015/0358115 A1
(43) Pub. Date: Dec. 10, 2015

(54) METHOD AND APPARATUS FOR PERFORMING TTI BUNDLING IN A TDD SYSTEM

(71) Applicant: NEC (CHINA) CO., LTD., Beijing (CN)

(72) Inventors: Gang WANG, Beijing (CN); Ming LEI, Beijing (CN)

(73) Assignee: NEC (CHINA) CO., LTD., Beijing (CN)

(21) Appl. No.: 14/759,952

(22) PCT Filed: Jan. 16, 2013
(86) PCT No.: PCT/CN2013/070519

§ 371 Date: Jul. 9, 2015

(51) Int. Cl. H04L 1/00; H04L 12/26; H04L 5/14

(52) U.S. Cl. CPC H04L 1/0045; H04L 5/1469; H04L 43/0852

(57) ABSTRACT

Embodiments of the present disclosure provide methods and apparatus for performing Transmission Time Interval (TTI) bundling in a Time Division Duplex (TDD) system. One of the methods may comprise receiving a first TTI bundling packet containing a first part of a redundancy version of a transport block on a special subframe and a second TTI bundling packet containing a second part of the redundancy version on another special subframe; and combining the first TTI bundling packet and the second TTI bundling packet to obtain the redundancy version of the transport block in a complete form. With embodiments of the present disclosure, more configurations may be used in TTI bundling for enhancing coverage in the TDD system, and it may avoid additional interferences to legacy UEs.

### FIELD OF THE INVENTION

Embodiments of the present disclosure generally relate to wireless communication techniques and more particularly relate to methods and apparatuses for performing TTI bundling in a TDD system.

### BACKGROUND OF THE INVENTION

With the constant increase of mobile data services and emergence of new-type applications, the 3rd Generation Partnership Project (3GPP) organization has developed long-term evolution (LTE) specifications and LTE-Advanced (LTE-A) specifications. As the next generation cellular communication standard, an LTE or LTE-Advance system can operate in both Frequency Division Duplex (FDD) mode and Time Division Duplex (TDD) mode.

In LTE release 8, an important technology called as Transmission Time Interval (TTI) bundling has been introduced so as to improve cell coverage and a coverage benefit has been observed from TTI bundling enhancements for uplink (UL) VoIP and medium size traffic. According to the TTI bundling, 4 consecutive subframes are bundled together to transmit a same transport block but with different redundancy versions and the bundled packet will be re-transmitted if an NACK is received by a UE. Specifically, as illustrated in FIG. 1A, for a same transport block, 4 different redundancy versions, i.e., RV0, RV1, RV2 and RV3 are generated by turbo coding and are transmitted to the BS on four normal UL subframes based on the resource allocation as illustrated in FIG. 1. At the BS, 4 different redundancy versions RV0 to RV3 will be decoded accordingly so as to obtain the transport block based thereon. If it fails to obtain the transport block, it will transmit an NACK to the UE, the UE will re-transmit the 4 redundancy versions in response to receiving such a NACK. However, due to the limited uplink resource, it is only possible to adopt TTI bundling for configurations 0, 1, and 6 among seven uplink/downlink (UL/DL) configurations for subframes. Therefore, TTI bundling is generally supported by both the FDD system and the TDD system with only UL/DL configurations 0, 1 and 6.

So far, in TD-SCDMA network (R1-121712, CMCC), it uses a subframe configuration comprising 5 DL subframes, 2 UL subframes, and special subframes in F band (1880-1920 MHz) and A band (2010-2025 MHz). For a scenario between a TDD system and the TD-SCDMA network, wherein the TDD system is deployed in either F band, A band or E band (2300-2400 MHz), there will be a problem to use TTI bundling. This lies in that the TD-SCDMA network usually uses a configuration of 5DL/2UL subframes and the most suitable UL/DL configuration for LTE TDD system or TD-LTE or TD-LTE-Advanced is configuration 2. However, as mentioned hereinabove, it is only possible to use TTI bundling for configuration 0, 1 and 6, and therefore, for configuration 2, it can't use TTI bundling to improve the cell coverage.

In view of the foregoing problem, there is a need for a solution of performing TTI bundling with configuration 2 so as to enhance coverage in the TDD system.

### SUMMARY OF THE INVENTION

In view of the foregoing, the present disclosure provides a new solution for performing TTI bundling in a TDD system so as to solve or at least partially mitigate at least a part of problems in the prior art.

According to a first aspect of the present disclosure, there is provided a method for performing TTI bundling at a base station. The method may comprise: receiving a first TTI bundling packet containing a first part of a redundancy version of a transport block on a special subframe and a second TTI bundling packet containing a second part of the redundancy version on another special subframe; and combining the first TTI bundling packet and the second TTI bundling packet to obtain the redundancy version of the transport block in a complete form.

In an embodiment of the present disclosure, the first part of the redundancy version may be one half of the redundancy version and the second part of the redundancy version may be the other half of the redundancy version.

In another embodiment of the present disclosure, a sequence of redundancy versions of the transport block used in the TTI bundling may be set according to an arrangement of subframes.

In a further embodiment of the present disclosure, the redundancy version of the transport block may be redundancy version 3.

In a still further embodiment of the present disclosure, each of the special subframe and the another special subframe may comprise a first portion for downlink transmission, a second portion for guard period, and a third portion for uplink transmission, and wherein lengths of the first portion, the second portion and the third portion may be set so that that transition time between the downlink transmission and the uplink transmission is substantially consistent with that for a special subframe of a legacy UE.

In a yet further embodiment of the present disclosure, the first portion, the second portion and the third portion may have a length ratio of 6:3:5.

In a still yet further embodiment of the present disclosure, the ratio of the number of resource blocks allocated to each of the special subframe and the another special subframe to the number of resource blocks allocated to a normal subframe may be 4:3.

In another embodiment of the present disclosure, the method may further comprise: determining whether a redundancy version segmentation is to be used in TTI bundling; and in response to determining that the redundancy version segmentation is to be used, sending to a user equipment (UE) an indication for indicating that the redundancy version segmentation is to be used in TTI bundling.

According to a second aspect, there is also provided a method for performing TTI bundling at a user equipment. The method may comprise: segmenting a redundancy version of a transport block into a first part and a second part; and transmitting a first TTI bundling packet containing the first part on a special subframe and a second TTI bundling packet containing the second part on another special subframe.

According to a third aspect, there is further provided an apparatus for performing TTI bundling in a TDD system. The apparatus may comprise: a packet receiving unit and a packet combination unit. The packet receiving unit may be configured to receive a first TTI bundling packet containing a first part of a redundancy version of a transport block on a special subframe and a second TTI bundling packet containing a second part of the redundancy version on another special subframe. The packet combination unit may be configured to combine the first TTI bundling packet and the second TTI bundling packet to obtain the redundancy version of the transport block in a complete form.

According to the fourth aspect of the present disclosure, there is still provided an apparatus for performing TTI bundling in a TDD system. The apparatus may further comprise: a version segmentation unit and a packet transmission unit. The version segmentation unit may be configured to segment a redundancy version of a transport block into a first part and a second part. The packet transmission unit may be configured to transmit a first TTI bundling packet containing the first part on a special subframe and a second TTI bundling packet containing the second part on another special subframe.

According to a fifth aspect of the present disclosure, there is provided an apparatus for uplink physical channel process in a TDD system. The apparatus may comprise a transport block segment module configured to segment a redundancy version of a transport block into a first part and a second part; a resource element mapper configured to perform a resource element mapping by mapping the first part and the second part of the redundancy version onto available uplink resources in a special subframe and another special subframe; and a transmitter, configured to transmit the first part and the second part based on the resource element mapping.

According a sixth aspect of the present disclosure, there is provided an apparatus for uplink physical channel process in TDD system. The apparatus may comprise a receiver configured to receive a first part and a second part of a redundancy version of a transport block on a special subframe and another special subframe; and a resource combination module configured to combine the first part and the second part of the redundancy version to obtain the redundancy version in a complete form.

According to a seventh aspect of the present disclosure, there is provided a computer-readable storage media with computer program code embodied thereon, the computer program code configured to, when executed, cause an apparatus to perform actions in the method according to any one of embodiments of the first aspect.

According to an eight aspect of the present disclosure, there is provided a computer-readable storage media with computer program code embodied thereon, the computer program code configured to, when executed, cause an apparatus to perform actions in the method according to any one of embodiments of the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, more configurations may be used in TTI bundling for enhancing coverage in the TDD system, and it may avoid additional interference to legacy UEs.

### BRIEF DESCRIPTION OF THE DRAWINGS

The above and other features of the present disclosure will become more apparent through detailed explanation on the embodiments as illustrated in the embodiments with reference to the accompanying drawings throughout which like reference numbers represent same or similar components and wherein:

FIG. 1A schematically illustrates a schematic diagram of TTI bundling subframes configuration in the prior art;

FIG. 1B schematically illustrates a resource block allocation for normal subframes in the prior art;

FIG. 2 schematically illustrates a flow chart of a method for use in a BS for performing a TTI bundling in a TDD system according to an embodiment of the present disclosure;

FIG. 3 schematically illustrates a flow chart of a method for use in a BS for performing a TTI bundling in a TDD system according to another embodiment of the present disclosure;

FIG. 4 schematically illustrates a flow chart of a method for use in a UE for performing a TTI bundling in a TDD system according to an embodiment of the present disclosure;

FIG. 5 schematically illustrate a diagram of a special subframe configuration according to an embodiment of the present disclosure;

FIG. 6A schematically illustrates a diagram of resource allocation for normal subframes according to an embodiment of the present disclosure;

FIG. 6B schematically illustrates a diagram of resource allocation for a special subframe which is used to transmit a first part of a redundancy version according to an embodiment of the present disclosure;

FIG. 6C schematically illustrates a diagram of resource allocation for a special subframe which is used to transmit a second part of a redundancy version according to an embodiment of the present disclosure;

FIG. 7 schematically illustrates a diagram of HARQ processes according to an embodiment of the present disclosure;

FIG. 8 schematically illustrates a diagram of uplink physical channel process with TTI bundling according to an embodiment of the present disclosure;

FIG. 9 schematically illustrates transition time in special subframes for Rel. 8 UEs and UEs under the present disclosure;

FIG. 10 schematically illustrates a block diagram of an apparatus for use in a BS for performing a TTI bundling in a TDD system according to an embodiment of the present disclosure;

FIG. 11 schematically illustrates a block diagram of an apparatus for use in a UE for performing a TTI bundling in a TDD system according to an embodiment of the present disclosure;

FIG. 12 illustrates the simulation results about the solution according to an embodiment of the present disclosure and the solution in the prior art.

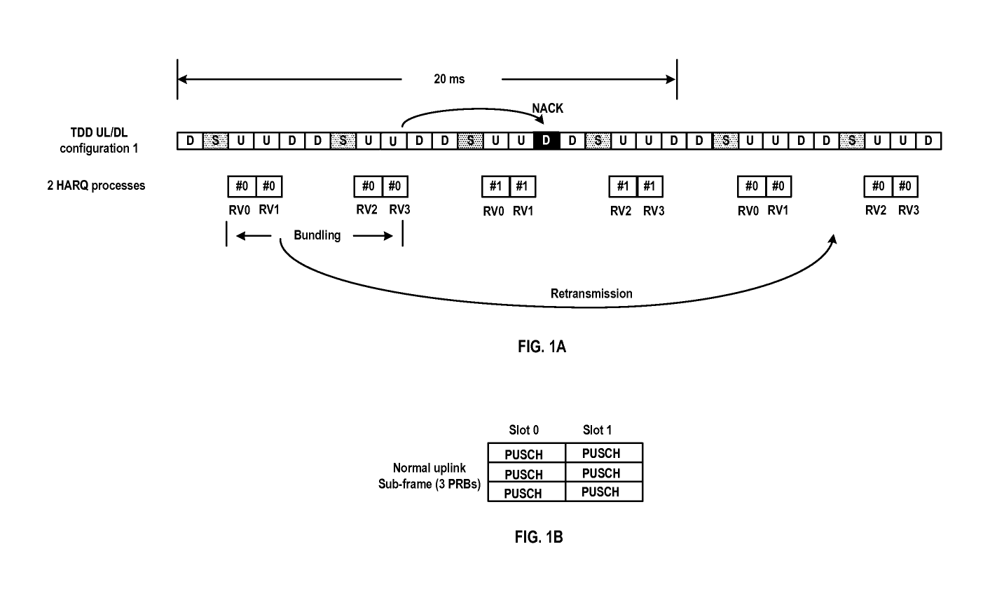

### DETAILED DESCRIPTION OF EMBODIMENTS

Hereinafter, a methods and apparatuses of performing TTI bundling in a TDD system will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or block may represent a module, a program, or a part of code, which contains one or more executable instructions for performing specified logic functions. In addition, an optional or additional element, device, component, means, step and etc., may be illustrated by a dotted block or dotted indication in any other form. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, a user equipment (UE) may refer to a terminal, a Mobile Terminal (MT), a Subscriber Station (SS), a Portable Subscriber Station (PSS), Mobile Station (MS), or an Access Terminal (AT), and some or all of the functions of the UE, the terminal, the MT, the SS, the PSS, the MS, or the AT may be included. Furthermore, in the context of the present disclosure, the term “BS” may represent, e.g., a node B (NodeB or NB), an evolved NodeB (eNodeB or eNB), a radio header (RH), a remote radio head (RRH), a relay, or a low power node such as a femto, a pico, and so on.

For a better understanding of the present disclosure, the following description will be made to embodiments of the present disclosure by taking the LTE TDD system as an example. However, as can be appreciated by those skilled in the art, the present invention can be applicable to any other suitable communication system.

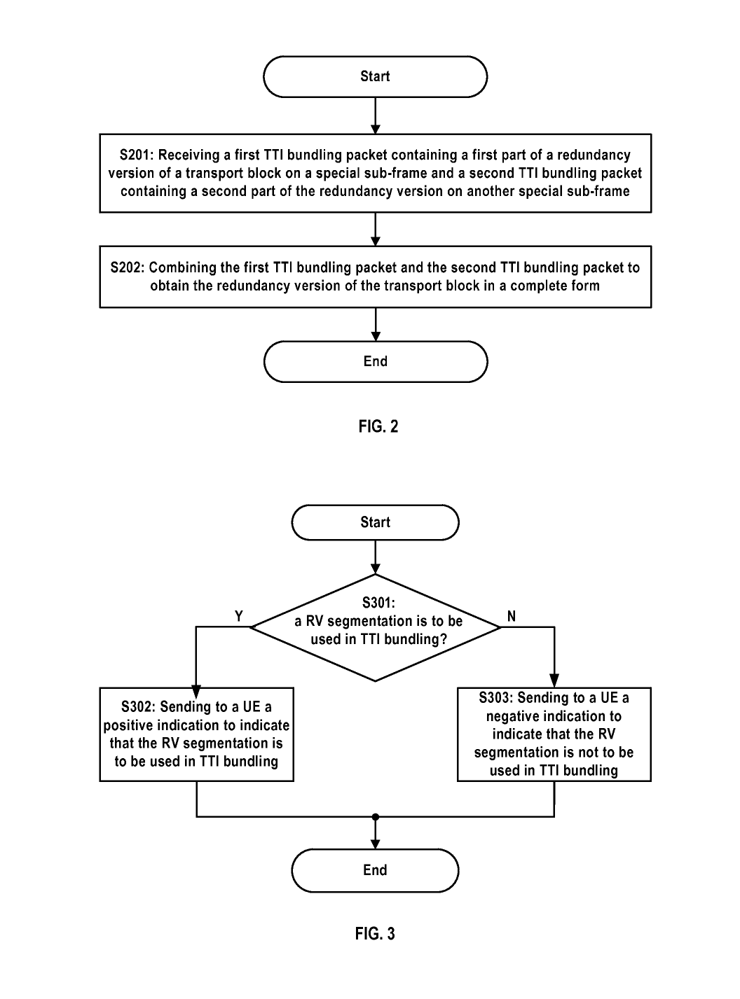

Hereinafter, reference is first made to FIG. 2 to describe the method of performing TTI bundling in a TTD system as provided in the present disclosure, which may be performed at a BS.

As illustrated in FIG. 2, first at S201, at the BS, a first TTI bundling packet containing a first part of a redundancy version of a transport block may be received on a special subframe, and a second TTI bundling packet containing a second part of the redundancy version may be received on another special subframe.

In the context of the present disclosure, a normal subframe refers to a subframe configured for either UL transmission (a UL subframe) or DL transmission (a DL subframe); and a special subframe is a subframe different from both the UL subframe and the DL subframe, which is located between the DL subframe and the UL subframe and is used for both the uplink transmission and the downlink transmission.

Taking the LTE TDD system as an example, there are seven different patterns of uplink/downlink UL/DL configurations, i.e, configurations 0 through 6, which are given in the following Table 1 for a purpose of illustration.

TABLE 1
UL/DL configurations in the LTE TDD system

| UL/DL | Subframe Number | | | | | | | | | |
|---|---|---|---|---|---|---|---|---|---|---|
| configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

As illustrated in Table. 1, a TDD radio frame consists of ten subframes labeled with 0 to 9. Each of the subframes may be used as a DL subframe, a UL subframe, or as a special subframe, which are labeled as “D”, “U” and “S” respectively. The special subframe comprises a Downlink Pilot Time Slot (DWPTS), a guard period (GP), and an Uplink Pilot Time Slot (UPPTS). However, it should be noted that the “S” subframe is only an example of the special subframe according to embodiments of the present disclosure.

Through the seven different UL/DL configurations, the LTE TDD system allows for asymmetric UL/DL allocation. However, as mentioned hereinabove, due to limitations of the UL resource in these configurations, TTI bundling is only supported by configurations 0, 1 and 6.

To support TTI bundling in more configurations, for example in configuration 2, the present inventors propose to segment a redundancy version of a transport block into two parts, which may be called as “redundancy version segmentation” or “transport block segmentation” in the present disclosure, and transmit them on two special subframes. Specifically, a RV may be selected from four redundancy versions for a transport block and the selected redundancy version will be divided into two parts at a UE. Preferably, one of the parts is one half of the RV and the other of the parts is the other half of the RV despite the fact that other division may be also feasible. The two parts may be contained in two different TTI bundling packets respectively and then transmitted on two special subframes. More details about the redundancy version segmentation and redundancy version transmission will be described hereinafter with reference to operations at UE.

Therefore, at the BS, it will receive a first TTI bundling packet containing a first part of the redundancy version on a special subframe and receive a second TTI bundling packet containing a second part of the redundancy version on another special subframe.

Then at step S202, the first TTI bundling packet and the second TTI bundling packet may be combined together to obtain the redundancy version of the transport block in a complete form.

As mentioned hereinabove, one redundancy version of the transport block will be segmented into two parts and transmitted in two different TTI bundling packets on two special subframes. Therefore, at the BS, the two TTI bundling packets each containing a part of the RV may be combined so as to obtain the complete RV therefrom. In such a way, this complete RV and other RVs may be further demodulated and turbo decoded and then are used to get information in the transport block.

In and embodiment of the present disclosure, when performing TTI bundling on the special subframe, redundancy versions for the TTI bundling packet will be configured based on the arrangement of subframes. It may be appreciated that a first subframe used in the TTI bundling may be a special subframe or a normal subframe, which use different transmission power. Generally, the power density of the resource blocks in the normal subframes is higher than that of the special subframes considering that more resource blocks are allocated in special subframes to carry the data information. In view of this, it will be preferable if the sequence of redundancy versions used in the TTI bundling may be set according to an arrangement of subframes so that a redundancy version with a lower priority is transmitted on the special subframe and redundancy version with higher priority are transmitted on normal UL subframes. Therefore, in an embodiment of the present disclosure, if a subframe used in the TTI bundling is a normal subframe, a redundancy version with a higher priority may be assigned thereto the subframe; and if a subframe used in the TTI bundling is a special subframe, a redundancy version with a lower priority may be assigned to the subframe. It is known that 4 different RVs are obtained by turbo coding but they have different priority or importance; and generally speaking, their priority descends in an order of RV0, RV2, RV3 and RV1. Thus, it is clear that it is preferable to transmit RV1 or RV3 on the two special subframes and transmit RV0 and RV2 on normal subframes.

Besides, it may also be appreciated that, in embodiments of the present disclosure, two special subframes are used to transmit one RV, which means that it will use only three RVs in TTI bundling instead of four RVs. Similarly, in a case that three RVs are used, it is preferable to select three redundancy versions with a higher priority. Foe example, it may choose RV0, RV2 and RV3, but it should be appreciated that it is also possible to use any other three RVs, such as RV0, RV1, RV2, and the like. Therefore, it is preferable if RV3 is transmitted on two special subframes and RV0 and RV2 are transmitted on normal UL subframes.

For example, in an embodiment of the present disclosure in which subframes for TTI bundling are arranged as “S U S U”, the sequence of the redundancy versions may be {3′, 0, 3″, 2}, wherein “0”, and “2” represent redundancy versions RV0 and RV2 respectively and “3′ and 3” represent the two part of the redundancy version RV3. In another embodiment of the present disclosure, if subframes for TTI bundling are arranged as “U S U S”, the sequence of the redundancy versions may be {0, 3′, 2, 3″}.

Besides, as illustrated in FIG. 3, before performing TTI bundling, the BS may further determine whether to use the redundancy version segmentation in TTI bundling at step S301.

The determination on whether the RV segmentation is to be used in the TTI bundling may be made by the BS according to current condition of the TDD system, for example, resource allocation, interference, signal quality, etc. As an alternative, the BS may first judge whether an agreement has been made between the BS and the UE to perform TTI bundling by means of the redundancy version segmentation, and if yes, the BS may determine that the redundancy version segmentation is to be applied in TTI bundling.

After that, at step S302, in response to determining that the RV segmentation is to be used in TTI bundling, an indication may be sent to a UE, to indicate that the redundancy version segmentation will be used in TTI bundling such that the UE segments one of the RV into two parts and transmits them on two special subframes. This indication may be briefly referred to as a “positive indication” herein after for a convenience of illustration.

The positive indication may be implemented in various forms. For example, the positive indication may be set as “TRUE” in response to determining that redundancy version segmentation is to be applied in TTI bundling. Then a message including the flag “TURE” may be sent to the UE, to notify the UE to segment one of RVs into two parts and transmit them on two special subframes. According to some other embodiments of the preset invention, the positive indication may be a specific predefined value, if the UE determines that the message sent from the BS includes the predefined value, e.g., 0 or 1, the UE will learn that the BS desires to perform TTI bundling by using the redundancy version segmentation.

On the other hand, if it determines that it will not use the redundancy version segmentation in TTI bundling, it may send no indication to the UE, such that the UE transmits TTI bundling packets as usual. If the UE fail to receive any positive indication, it may know that the BS does not desire to perform TTI bundling by using the redundancy version segmentation. As an alternative, at step S303, the BS may sent a message including a negative indication, e.g., “FALSE” to the UE, so as to provide a more explicit notification.

According to an embodiment of the present disclosure, the positive and negative indications may be implemented by a Radio Resource Control (RRC) signaling. In an embodiment, a RRC signaling may be configured as including the indication and then the RRC signaling may be sent to the UE. It is to be noted that, the message according to embodiments of the present disclosure may be implemented in other suitable forms, and the RRC signaling is just provided for a purpose of illustration rather than limitation.

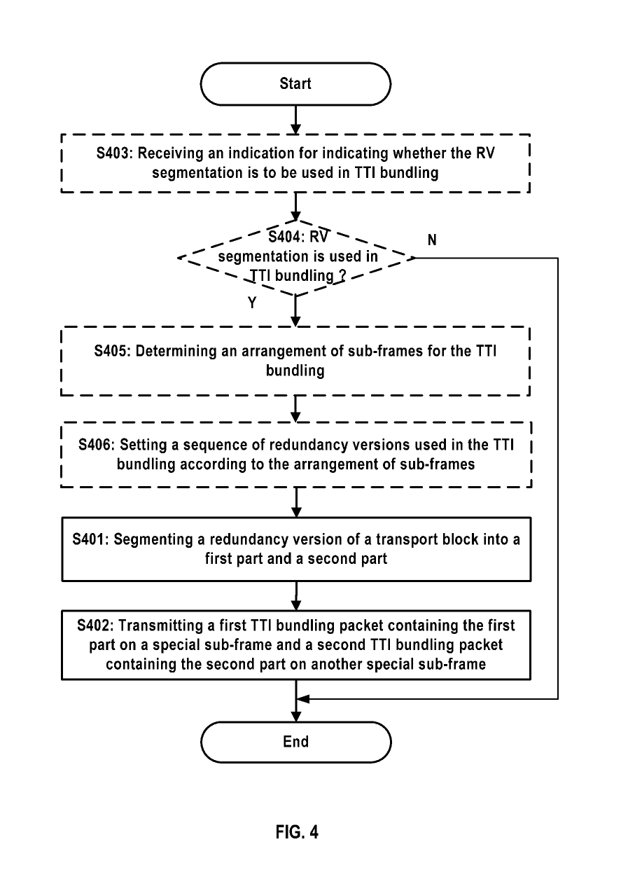

Next, reference will be made to FIGS. 4 to 8 to describe the method for performing TTI bundling according to an embodiment of the present disclosure, which may be performed at a UE.

As illustrated in step S401, a redundancy version of a transport block will be segmented into a first part and a second part.

As has been described hereinabove, one of redundancy versions will be transmitted on two special subframes and thus three redundancy version will be used in TTI bundling in stead of four redundancy versions in the prior art. Therefore, it is preferable to select three redundancy versions form 4 different RVs obtained by turbo coding based on their priorities or importance. In an embodiment of the present disclosure, it may select three redundancy versions with higher priorities from the four redundancy versions. Therefore, it is preferable to select RV0, RV2 and RV3 as the three redundancy versions, but it is also possible to use any other redundancy versions such as RV0, RV1 and RV2, and the like.

Additionally, the power density of a special subframe will usually be lower than that of a normal subframe. Therefore, it will be preferable if the redundancy version to be segmented or to be transmitted on special subframes is selected from the three redundancy version according to the priorities or importance of redundancy versions of the transport block. In an embodiment of the present disclosure, it may select, from the three redundancy versions to be used in TTI bundling, a redundancy version with a lower priority as the redundancy version to be segmented. However, it may be also practicable to select another one as the redundancy version to be segmented.

For example, in a case of using redundancy versions RV0, RV2 and RV3, RV3 may be determined as the redundancy version to be segmented.

The redundancy version to be transmitted on the special subframes will be segmented into two parts, i.e., a first part and a second part. For example, it may be divided into two halves, which means a first part is one half of the redundancy version and the second part is the other half of the redundancy version.

Then at step S402, the two parts may be contained in two separate TTI bundling packets and transmitted on two special subframes, respectively.

After the redundancy version has been segmented into two parts, they may be transmitted on the two special subframes. To enable a redundancy version to transmitted on two special subframes in the TTI bundling, a structure for the special subframe is newly proposed in embodiments of the present disclosure. In accordance with embodiments of the present disclosure, the special subframe may comprise a first portion for DL transmission, a second portion for guard period (GP), and a third portion for UL transmission, and wherein the length of the first portion, the second portion and the third portion are set so that that transition time between the downlink transmission and the uplink transmission is substantially consistent with that for a special subframe of a legacy UE so as to avoid any possible interference to the legacy UE.

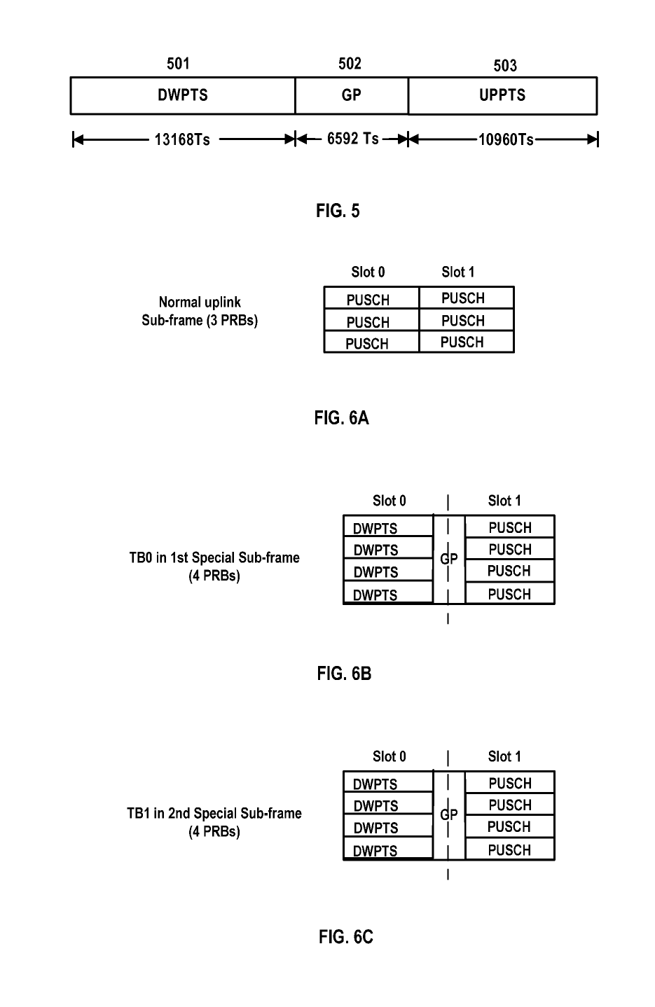

Reference is now made to FIG. 5, which schematically illustrates an exemplary diagram of a special subframe 500 according to an embodiment of the present disclosure. As shown in FIG. 5, the special subframe 500 comprise a first portion, DWPTS 501, a second portion, GP 502, and a third portion, UPPTS 503. In an embodiment of the present invention, the first portion, the second portion and the third portion may have a length ratio of 6:3:5. That is to say, assuming that the length of one subframe is 1 ms, the length of DWPTS 501 may be set as approximately 13168 Ts (about 0.429 ms), the length of the GP 502 is approximately 6592 Ts (about 0.215 ms) and the length of the UPPTS 503 may be set as about 10960 Ts (nearly 0.357 ms).

Additionally, in the present disclosure, to enable a redundancy version to transmitted on two special subframes in the TTI bundling, enough resource blocks should be allocated. In an embodiment of the present invention, the ratio of the number of resource blocks allocated to each of the special subframe to the number of resource blocks allocated to a normal subframe may be 4:3. Reference may be made to FIG. 6A to 6C to make a more detailed illustration.

Reference may be first made to FIG. 6A, which illustrates a diagram of resource allocation for a normal subframe according to embodiments of the present disclosure. In the embodiments illustrated with respect to FIG. 6A, the normal subframe is an uplink subframe, e.g., “U” subframe in a LTE TDD system, which comprises two slots, Slot 0 and Slot 1, both of them being used for uplink transmission. As shown, three resource blocks, e.g. 3 physical resource blocks (PRBs), are allocated to each subframe. The uplink transmission is performed on Physical Uplink Shared Channel (PUSCH).

Next, reference is made to FIGS. 6B and 6C, which respectively illustrate diagrams of resource allocation for a first part and a second part (TB0 and TB1) of the transport block in a first special subframe and a second special subframe according to embodiments of the present disclosure. In the embodiments illustrated with respect to FIGS. 6B and 6C, the special subframe is for example the “S” subframe in the LTE TDD system, which also comprises two slots, Slot 0 and Slot 1. Different from the normal subframe shown in FIG. 6A, in the special subframe, Slot 0 is assigned for DWPTS and GP and Slot 1 is assigned for uplink transmission and GP. For ensuring enough resource to transmit TB0 and TB1, four resource blocks, e.g. 4 PRBs, are allocated to each of the special subframe. In this way, there are nearly six resource blocks in total for uplink transmission.

If the redundancy version segmentation is to be used in the TTI bundling, in the first special sub-fame, the first part of the redundancy version, or called as the first element of the transport block TB pair, may be mapped into the available uplink resource in the transmitter. The second part of the redundancy version, or called as the second element of the transport block pair, may be mapped in the available uplink resource in the second special subframe.

That is to say, if a ttiBundling_special_segmentation is used to indicate whether to use two special subframes to transmit the TB pair in TTI bundling, when ttiBundling_special_segmentation is set to true, the TB pair shall be mapped to the first and the second special subframes separately. The mapping to resource element (k, 1) corresponding to the physical resource blocks assigned for transmission shall be in increasing order of first the index k, then the index 1, and all TB pairs starting with the second slot in the subframe and not part of the guard period.

In such a way, it may transmit TTI bundling packets on the special subframes. Additionally, When the UPPTS 503 in the special subframe as illustrated in FIG. 5 is assigned to UE to transmit sounding reference signal (SRS) or physical random access channel (PRACH), the UE may carry out rate matching in the UPPTS when the special subframe is also used for TTI bundling. In view of the fact that the SRS and PRACH transmission is configured by the BS, the base station could easily recover the TTI bundling packets without any additional signaling although the rate matching is performed.

Reference is made back to FIG. 4. As illustrated, at step S403, it may further receive an indication for indicating whether the redundancy version segmentation is to be used in TTI bundling. As described hereinabove, the BS may determine whether to perform TTI bundling by means of the redundancy version segmentation, and in such a case it will send to the UE an indication. The UE may receive the indication and determine therefrom whether to perform TTI bundling by means of the redundancy version segmentation at step S404. If it determines that it is required to perform the TTI by means of the redundancy version segmentation, the method may be proceeded; otherwise the method may be ended.

In addition, as mentioned hereinabove, a first subframe used in the TTI bundling may be a special subframe or a normal subframe, which use different transmission power. Thus, when performing TTI bundling on the special subframe, it is preferable to configure the redundancy versions to be used in the TTI bundling for different arrangements of subframes. Therefore, in an embodiment of the present disclosure, an arrangement of subframes for the TTI bundling is determined as step S405. Then, at step S406, a sequence of redundancy versions to be used in the TTI bundling is set according to the arrangement of subframes. For example, if a subframe used in the TTI bundling is a normal subframe, a redundancy version with a higher priority may be assigned thereto; and if a subframe used in the TTI bundling is a special subframe, a redundancy version with a lower priority may be assigned to the subframe.

Thus, it may be preferable to transmit RV1 or RV3 on the two special subframes and transmit RV0 and RV2 on normal subframes. More preferably, redundancy version RV3 is transmitted on the two special subframes. As an example, in case of the subframe arrangement of “S U S U”, the sequence of the redundancy versions may be {3′, 0, 3″, 2}; and in another case of the subframe arrangement of “U S U S”, the sequence of the redundancy versions may be {0, 3′, 2, 3″}.

Thus, when the redundancy version segmentation according to embodiments of the present disclosure is applied, not only the UL/DL configurations 0, 1 and 6 that have supported TTI bundling, but also the UL/DL configuration 2 which is not qualified for TTI bundling, may use the TTI bundling scheme to benefit therefrom. According to some embodiments of the present disclosure, the number of HARQ processes for the TTI bundling with respect to UL/DL configuration 2 may be up to 2.

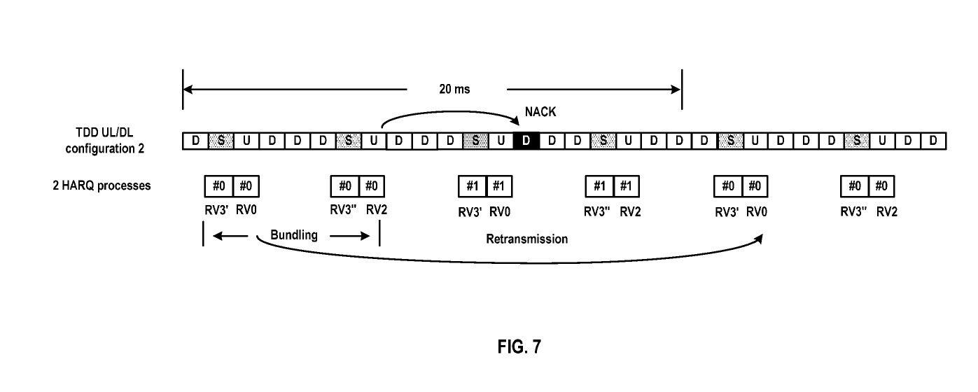

Reference is now made to FIG. 7, which illustrates a diagram of HARQ processes according to an embodiment of the present disclosure. Specifically, in the embodiment as illustrated with FIG. 7, TDD UL/DL configuration 2 is employed in TTI bundling. As shown, there are three redundant versions (RVs), RV3, RV0, and RV2 bundled, wherein RV3 is segmented into two parts RV3′ and RV3″. The first part RV3′ of the redundant version RV3 is transmitted from the UE to the BS on the first “S” subframe; next, the second redundant version, RV0, is transmitted to the BS on the first “U” subframe; subsequently, since RV should be transmitted to the BS and there are three successive “D” subframes followed, there is no RV transmitted; following the three “D” subframes, another two “S” and “U” subframes are used to transmit the second part RV3″ of the redundancy version RV3 and the last redundant version RV2. In this way, the first set (e.g., denoted as “#0”) of redundant versions has been transmitted in uplink on two special subframes and two normal subframes (uplink normal subframes). Then, similarly, a second set (e.g., denoted as “#1”) of 3 redundant versions may be transmitted to the BS on the subsequent “S” and/or “U” subframes. As shown in FIG. 7, after the first set of RVs has been transmitted, a response (e.g., ACK or NACK) may be received in a “D” subframe after a period of time. In the embodiment, when the UE receives a response of NACK, which indicates the BS does not properly receive the uplink packets, the UE will retransmit the first set of RVs. Hence, the UE may check the upcoming “S” subframe or “U” subframe so as to begin the retransmission of the first set of RVs. However, since the second set of RVs is being transmitted, the upcoming “S” or “U” subframe can not be used for the retransmission of the first set. Therefore, the UE will find other “S” subframe or “U” subframe which does not interfere with the second set of RVs. As shown in FIG. 7, the retransmission of the first set of RVs begins after the transmission of the second set has finished.

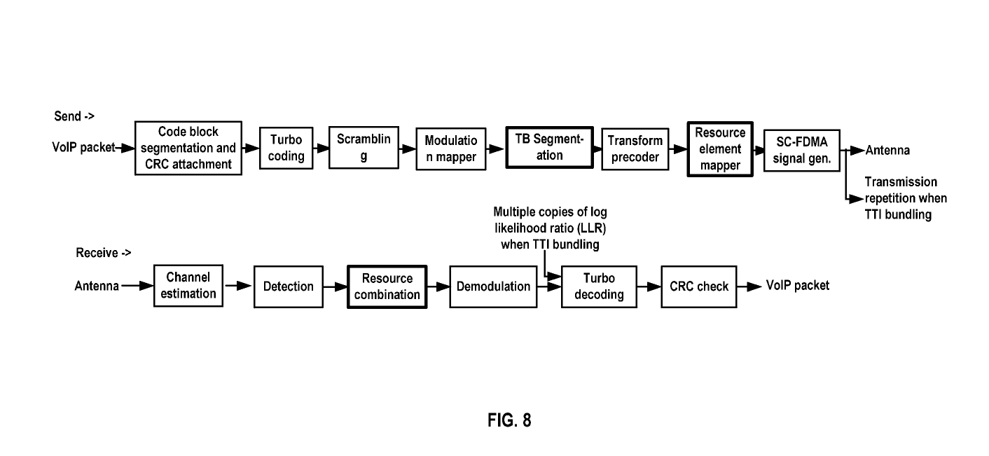

Additionally, with the redundancy version segmentation as proposed in the present invention, the uplink physical channel processing with TTI bundling will be different to those in prior art. Next reference will be made to FIG. 8 to describe the differences in which the main differences are illustrated by blocks in black heavy lines.

As illustrated, at a UE, there is newly added a transport block segmentation module, which is responsible for segmenting a redundancy version of a transport block into a first part and a second par; and besides, the resource element mapper will be perform resource mapping based on the resource allocated as proposed in the present disclosure, specifically, it may map the two parts onto the available uplink resources in a first special subframe and a second special subframe, respectively. Then the antenna will transmit two TTI bundling packets at two special subframes based on the resource element mapping. Further, at the BS, there is newly added a resource combination, which is configured to combine the two TTI bundling packets together to obtain the redundancy version of the transport block in a complete form.

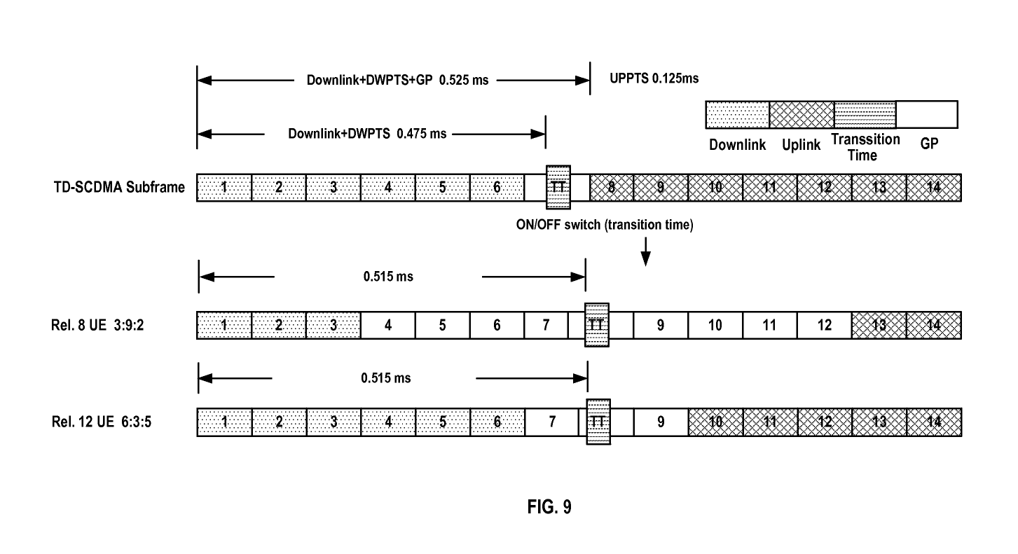

With embodiments of the present invention, it may not only enable more configurations to benefit from TTI bundling, but also avoid additionally interference to legacy users since the transmit time between the DL and UL may be substantially consistent with that for legacy UEs. This will be explained with reference to FIG. 9, which schematically illustrates transition time in special subframes for Rel. 8 UEs and UEs under the present disclosure.

From FIG. 9, it can be seen that in the present disclosure, it uses a special subframe configuration of 6:3:5, or in other word, the DL, GP and UP have a length ratio of 6:3:5. Comparing with the legacy UEs, i.e., Rel. 8 UEs, which use special subframe configuration 5 which has a length ratio of 3:9:2, the transition time in GP in the present disclosure may be substantially consistent with that for Rel. 8 UEs. Therefore, the solution as provided in the present invention will not cause any additional interference to the legacy UEs, which provides a substantial advantage. Additionally, the solution as provided in the present invention will not cause any interference to TD-SCDMA system.

Besides, according to embodiments of the present disclosure, it may make some changes with respect to the existing configurations of the special subframe.

For example, in Section 5.3.4 of TS 36/211, it may add a new mapping scheme to physical resource. For example, it may add such a statement as “When ttiBundling_special_segmentation is set to true, the TB pair shall be mapped to the first and the second special subframes separately. The mapping to resource element (k, 1) corresponding to the physical resource blocks assigned for transmission shall be in increasing order of first the index k, then the index 1, and all TB pairs starting with the second slot in the subframe and not part of the guard period”.

In addition, in Table 4.2-1 of TS 36.211, a special subframe configuration 10 having a length ratio of 6:3:5 and a configuration for extended cyclic prefix may be newly added, which are highlighted by both underline and bold face in the following Table 2.

TABLE 2
Configuration of special subframe (lengths of DwPTS/GP/UpPTS)

| | Normal cyclic prefix in downlink | | | Extended cyclic prefix in downlink | | |
|---|---|---|---|---|---|---|
| | | UpPTS | | | UpPTS | |
| | | Normal | | | | |
| | | cyclic | Extended | | Normal | |
| Special | | prefix | cyclic | | cyclic | Extended |
| subframe | | in | prefix | | prefix in | cyclic prefix |
| configuration | DwPTS | uplink | in uplink | DwPTS | uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | 12800 Ts | 10960 Ts | 10240 Ts |
| 9 | 13168 · Tₛ | | | — | — | — |
| 10 | 13168 Ts | 10960 Ts | 10240 TS | | | |

Furthermore, it may make some changes to Table 8-1 of TS 36.213 in the case that the redundancy version segmentation is applied in TTI bundling. Details are shown in Table 3, wherein insertion is highlighted by underline and deletion is shown in strike through.

TABLE 3
Number of synchronous UL HARQ processes for TDD

| | Number of HARQ | |
|---|---|---|
| TDD UL/DL | processes for | Number of HARQ processes for |
| configuration | normal HARQ operation | subframe bundling operation |
| 0 | 7 | 3 |
| 1 | 4 | 2 |
| 2 | 2 | 2 |
| 3 | 3 | N/A |
| 4 | 2 | N/A |
| 5 | 1 | N/A |
| 6 | 6 | 3 |

Besides, there may be also some changes made to Table 8-2 of TS 36.213. Details are shown in Tables 4 and 5. Table 4 shows the values of “k” for TDD UL/DL configurations 0-6 when the redundancy version (RV) segmentation is disabled, wherein the symbol “k” indicates the number of subframes the UE will wait before sending the packets at n+k subframe.

TABLE 4
k for TDD configurations 0-6 when the RV segmentation is disabled

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Table 5 shows the values of “k” for TDD UL/DL configuration 2 when the redundancy version segmentation is enabled, wherein insertion is highlighted by underline.

TABLE 5
k for TDD configuration 2 when the RV segmentation is enabled

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 2 | | 5 | | 4 | | | 5 | | 4 | |

There may be also some changes made to Table 8-2a of TS 36.213 in the case that the redundancy version segmentation is applied in TTI bundling. Details are shown in Table 6. Table 6 shows the values of “1” for TDD UL/DL configurations 0-6, wherein the symbol “1” indicates that UE receives ACK/NACK at n−1 subframe, wherein insertion is highlighted by underline.

TABLE 6
l for TDD configurations 0, 1, 2 and 6 when the
RV segmentation is enabled

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 9 | 6 | | | | 9 | 6 | | | |
| 1 | | 2 | | | 3 | | 2 | | | 3 |
| 2 | | 3 | | 3 | | | 3 | | 3 | |
| 6 | 5 | 5 | | | | 6 | 6 | | | 8 |

Additionally, Table 9.1.2-1 of TS 36.213 may be also changed in the case that the RV segmentation is applied in TTI bundling. Details are shown in Tables 7 and 8. Table 7 shows the values of “k_{PHICH}” for TDD UL/DL configurations 0-6 when the RV segmentation is disabled, wherein “k_{PHICH}” indicates the number of subframes UE needs to wait to receive ACK/NACK after base station sending it out.

TABLE 7
k_{PHICH} for TDD when the RV segmentation is disabled

| TDD UL/DL | subframe index n | | | | | | | | | |
|---|---|---|---|---|---|---|---|---|---|---|
| Configuration | 0 | 1 | 2 | 3 | 4 | 5 | 6 | 7 | 8 | 9 |
| 0 | | | 4 | 7 | 6 | | | 4 | 7 | 6 |
| 1 | | | 4 | 6 | | | | 4 | 6 | |
| 2 | | | 6 | | | | | 6 | | |
| 3 | | | 6 | 6 | 6 | | | | | |
| 4 | | | 6 | 6 | | | | | | |
| 5 | | | 6 | | | | | | | |
| 6 | | | 4 | 6 | 6 | | | 4 | 7 | |

Table 8 shows the values of “k_{PHICH}” for TDD UL/DL configurations 2, when the RV segmentation is enabled, wherein insertion is highlighted by underline.

TABLE 8
k_{PHICH} for TDD UL/DL configurations 2 when the RV
segmentation is enabled

| TDD UL/DL | subframe index n | | | | | | | | | |
|---|---|---|---|---|---|---|---|---|---|---|
| Configuration | 0 | 1 | 2 | 3 | 4 | 5 | 6 | 7 | 8 | 9 |
| 2 | | 4 | 6 | | | | 4 | 6 | | |

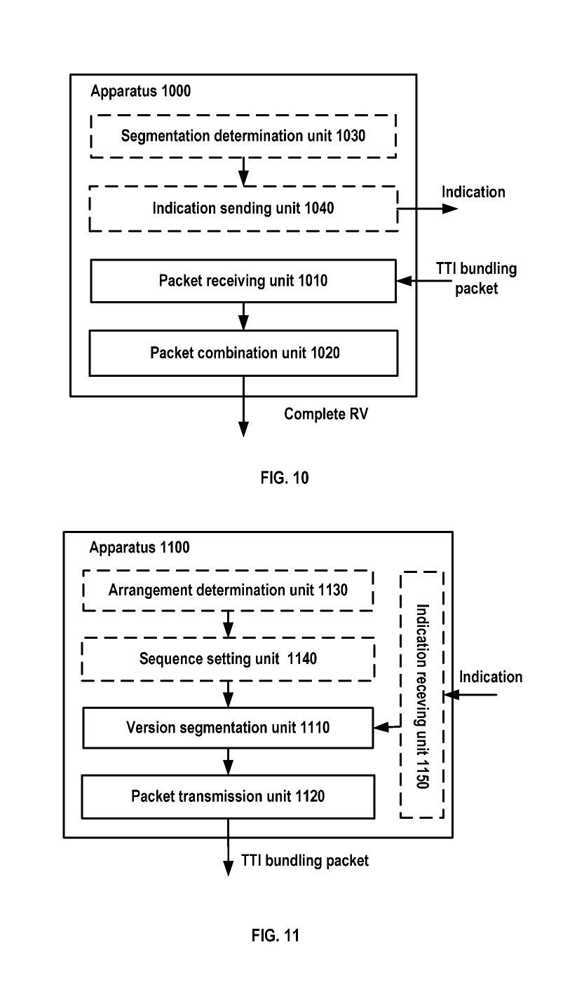

Additionally, in the present disclosure, there is provided an apparatus for performing TTI bundling in a TDD system. Now reference is now made to FIG. 10, which illustrates a block diagram of apparatus for performing TTI bundling in a TDD system according to an embodiment of the present disclosure, to describe the apparatus as provided in the present disclosure.

As illustrated in FIG. 10, apparatus 1000 may comprise: a packet receiving unit 1010 and a packet combination unit 1020. The packet receiving unit 1010 may be configured to receive a first TTI bundling packet containing a first part of a redundancy version of a transport block on a special subframe and a second TTI bundling packet containing a second part of the redundancy version on another special subframe. The packet combination unit 1020 may be configured to combine the first TTI bundling packet and the second TTI bundling packet to obtain the redundancy version of the transport block in a complete form.

In an embodiment of the present invention, the first part of the redundancy version may be one half of the redundancy version and the second part of the redundancy version may be the other half of the redundancy version.

In another embodiment of the present disclosure, a sequence of redundancy versions of the transport block used in the TTI bundling may be set according to an arrangement of subframes.

In a further embodiment of the present disclosure, the redundancy version of the transport block may be redundancy version 3.

In a still further embodiment of the present disclosure, each of the special subframe and the another special subframe may comprise a first portion for downlink transmission, a second portion for guard period, and a third portion for uplink transmission. The lengths of the first portion, the second portion and the third portion may be set so that that transition time between the downlink transmission and the uplink transmission is substantially consistent with that for a special subframe of a legacy UE.

In a yet further embodiment of the present disclosure, the first portion, the second portion and the third portion may have a length ratio of 6:3:5.

In a still yet further embodiment of the present disclosure, the ratio of the number of resource blocks allocated to each of the special subframe and the another special subframe to the number of resource blocks allocated to a normal subframe may be 4:3.

In another embodiment of the present disclosure, apparatus may further comprise a segmentation determination unit 1030, which may be configured to determine whether a redundancy version segmentation is to be used in TTI bundling; and an indication sending unit 1040, which may be configured to, in response to determining that the redundancy version segmentation is to be used, send to a user equipment (UE) an indication for indicating that the redundancy version segmentation is to be used in TTI bundling.

Besides, there is further provided an apparatus for performing TTI bundling in a TDD system. In the following, reference will be made to FIG. 11, which illustrates a block diagram of an apparatus for performing TTI bundling in a TDD system according to an embodiment of the present disclosure, to describe the apparatus as provided in the present disclosure.

As illustrated, apparatus 1100 may further comprise a version segmentation unit 1110 and a packet transmission unit 1120. The version segmentation unit 1110 may be configured to segment a redundancy version of a transport block into a first part and a second part. The packet transmission unit 1120 may be configured to transmit a first TTI bundling packet containing the first part on a special subframe and a second TTI bundling packet containing the second part on another special subframe.

In an embodiment of the present disclosure, the first part of the redundancy version may be one half of the redundancy version and the second part of the redundancy version may be the other half of the redundancy version.

In another embodiment of the present disclosure, apparatus 1100 may comprise: an arrangement determination unit 1130, which may be configured to determine an arrangement of subframes for the TTI bundling; and a sequence setting unit 1140, which may be configured to set a sequence of redundancy versions used in the TTI bundling according to the arrangement of subframes.

In a further embodiment of the present disclosure, the redundancy version of the transport block may be redundancy version 3.

In a still embodiment of the present disclosure, each of the special subframe and the another special subframe may comprise a first portion for downlink transmission, a second portion for guard period, and a third portion for uplink transmission. The lengths of the first portion, the second portion and the third portion may be set so that that transition time between the downlink transmission and the uplink transmission is substantially consistent with that for a special subframe of a legacy UE.

In a yet further embodiment of the present disclosure, the first portion, the second portion and the third portion may have a length ratio of 6:3:5.

In a still yet further embodiment of the present disclosure, the ratio of the number of resource blocks allocated to each of the special subframe and the another special subframe to the number of resource blocks allocated to a normal subframe may be 4:3.

In another embodiment of the present disclosure, the apparatus 1100 may further comprise: an indication receiving unit 1150, which may be configured to receive an indication for indicating that the redundancy version segmentation is to be used in TTI bundling. And in such a case, the version segmentation unit 1110 and the packet transmission unit 1120 may be configured to operate in response to receiving the indication.

It is noted that the apparatus 1000 may be configured to implement functionalities as described with reference to FIGS. 2 and 3, and the apparatus 1100 may be configured to implement functionalities as described with reference to FIG. 4. Therefore, for details about the operations of modules in these apparatus, one may refer to those descriptions made with respect to the respective steps of the methods with reference to FIGS. 2 to 9.

It is further noted that the components of the apparatuses 1000 and 1100 may be embodied in hardware, software, firmware, and/or any combination thereof. For example, the components of the apparatus 1000 or 1100 may be respectively implemented by a circuit, a processor or any other appropriate selection device. Those skilled in the art will appreciate that the aforesaid examples are only for illustration not limitation.

In some embodiment of the present disclosure, the apparatus 1000 comprises at least one processor. The at least one processor suitable for use with embodiments of the present disclosure may include, by way of example, both general and special purpose processors already known or developed in the future. The apparatus 1000 further comprises at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the apparatus 1000 to at least perform operations according to the method as discussed with reference to FIGS. 2 and 3.

In some embodiment of the present disclosure, the apparatus 1100 comprises at least one processor. The at least one processor suitable for use with embodiments of the present disclosure may include, by way of example, both general and special purpose processors already known or developed in the future. The apparatus 1100 further comprises at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the apparatus 1100 to at least perform operations according to method as discussed with reference to FIG. 4.

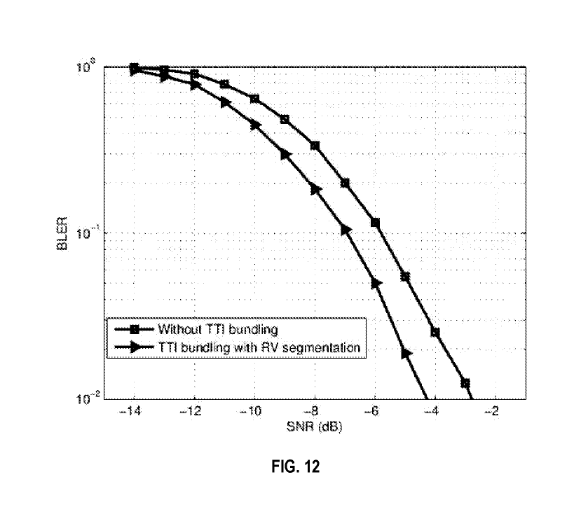

In addition, FIG. 12 further illustrates simulation results made on an embodiment of the present invention and the existing solution in the prior art. Parameters used in the simulations are listed in Table 9.

TABLE 9
Parameters used in the simulations

| Parameter | Assumptions used for simulation |
|---|---|
| Bandwidth | 10 MHz |
| Carrier Frequency | 2 GHz |
| Antenna Congiration | UL 1*2 SIMO |
| Channel Mode | EPA channel |
| Mobile speed | 3 km/h |
| Channel Estimation | Ideal |
| Frequency hopping | No |
| HARQ RV | 1′, 0, 1″, 2 |
| PRB | 3 for normal special sub-frame, 4 for special |
| | sub-frame |
| TBS | 328 bit |
| MCS | I_TBS = 7, QPSK |

From FIG. 12, it is clear that TTI bundling with a special subframe configuration of 6:3:5 may achieve a substantial performance enhancement (about 1.4 dB SNR gains) without causing any interference the legacy UEs.

It should be noted that in the present disclosure, the method described with reference to FIGS. 2 and 3 may be carried out by, for example, a BS, a base station controller (BSC), a gateway, a relay, a server, or any other applicable device. Additionally, the method described with reference to FIG. 4 may be carried out by, for example, a UE, a terminal, a Mobile Station, or any other applicable device.

Although embodiments of the present invention have been described with reference to the LTE TDD system, the present invention may also be applicable in any other appropriate TDD system such as TD-SCDMA, and etc to benefit therefrom.

It also should be appreciated that embodiments of the present invention have been described with reference to configuration 2; however, it may also be used in other configuration such as configuration 0, 1 and 6 so as to benefit therefrom.

Based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in the companying drawings may be viewed as method steps, and/or as operations that result from operation of computer program code, and/or as a plurality of coupled logic circuit elements constructed to carry out the associated function(s). At least some aspects of the exemplary embodiments of the disclosures may be practiced in various components such as integrated circuit chips and modules, and that the exemplary embodiments of this disclosure may be realized in an apparatus that is embodied as an integrated circuit, FPGA or ASIC that is configurable to operate in accordance with the exemplary embodiments of the present disclosure.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1-34. (canceled)

35. A method for performing Transmission Time Interval (TTI) bundling in a Time Division Duplex (TDD) system, the method comprising:
receiving a first TTI bundling packet containing a first part of a redundancy version of a transport block on a special subframe and a second TTI bundling packet containing a second part of the redundancy version on another special subframe; and
combining the first TTI bundling packet and the second TTI bundling packet to obtain the redundancy version of the transport block in a complete form.

36. The method according to claim 35, wherein the first part of the redundancy version is one half of the redundancy version and the second part of the redundancy version is the other half of the redundancy version.

37. The method according to claim 35, wherein a sequence of redundancy versions of the transport block used in the TTI bundling is set according to an arrangement of subframes, and wherein the redundancy version of the transport block is redundancy version 3.

38. The method according to claim 35, wherein each of the special subframe and the another special subframe comprises a first portion for downlink transmission, a second portion for guard period, and a third portion for uplink transmission, and wherein lengths of the first portion, the second portion and the third portion are set so that that transition time between the downlink transmission and the uplink transmission is substantially consistent with that for a special subframe of a legacy UE.

39. The method according to claim 38, wherein the first portion, the second portion and the third portion have a length ratio of 6:3:5 and wherein the ratio of the number of resource blocks allocated to each of the special subframe and the another special subframe to the number of resource blocks allocated to a normal subframe is 4:3.

40. The method according to claim 35, further comprising:
determining whether a redundancy version segmentation is to be used in TTI bundling; and
in response to determining that the redundancy version segmentation is to be used, sending to a user equipment (UE) an indication for indicating that the redundancy version segmentation is to be used in TTI bundling.

41. A method for performing Transmission Time Interval (TTI) bundling in a Time Division Duplex (TDD) system, the method comprising:
segmenting a redundancy version of a transport block into a first part and a second part; and
transmitting a first TTI bundling packet containing the first part on a special subframe and a second TTI bundling packet containing the second part on another special subframe.

42. The method according to claim 41, wherein the first part of the redundancy version is one half of the redundancy version and the second part of the redundancy version is the other half of the redundancy version.

43. The method according to claim 41, further comprising:
determining an arrangement of subframes for the TTI bundling; and
setting a sequence of redundancy versions used in the TTI bundling according to the arrangement of subframes,
wherein the redundancy version of the transport block is redundancy version 3.

44. The method according to claim 41 wherein each of the special subframe and the another special subframe comprises a first portion for downlink transmission, a second portion for guard period, and a third portion for uplink transmission, and wherein lengths of the first portion, the second portion and the third portion are set so that that transition time between the downlink transmission and the uplink transmission is substantially consistent with that for a special subframe of a legacy UE.

45. The method according to claim 44, wherein the first portion, the second portion and the third portion have a length ratio of 6:3:5 and wherein the ratio of the number of resource blocks allocated to each of the special subframe and the another special subframe to the number of resource blocks allocated to a normal subframe is 4:3.

46. The method according to claim 41, further comprising:
receiving an indication for indicating that the redundancy version segmentation is to be used in TTI bundling;
wherein the segmenting and the transmitting are performed in response to receiving the indication.

47. An apparatus for performing Transmission Time Interval (TTI) bundling in a Time Division Duplex (TDD) system, the apparatus comprising:
a packet receiving unit configured to receive a first TTI bundling packet containing a first part of a redundancy version of a transport block on a special subframe and a second TTI bundling packet containing a second part of the redundancy version on another special subframe; and
a packet combination unit configured to combine the first TTI bundling packet and the second TTI bundling packet to obtain the redundancy version of the transport block in a complete form.

48. The apparatus according to claim 47, wherein the first part of the redundancy version is one half of the redundancy version and the second part of the redundancy version is the other half of the redundancy version.

49. The apparatus according to claim 37, wherein a sequence of redundancy versions of the transport block used in the TTI bundling is set according to an arrangement of subframes, and wherein the redundancy version of the transport block is redundancy version 3.

50. The apparatus according to claim 47, wherein each of the special subframe and the another special subframe comprises a first portion for downlink transmission, a second portion for guard period, and a third portion for uplink transmission, and wherein lengths of the first portion, the second portion and the third portion are set so that that transition time between the downlink transmission and the uplink transmission is substantially consistent with that for a special subframe of a legacy UE.

51. The apparatus according to claim 50, wherein the first portion, the second portion and the third portion have a length ratio of 6:3:5, and wherein the ratio of the number of resource blocks allocated to each of the special subframe and the another special subframe to the number of resource blocks allocated to a normal subframe is 4:3.

52. The apparatus according to claim 47, further comprising:
a segmentation determination unit configured to determine whether a redundancy version segmentation is to be used in TTI bundling; and
an indication sending unit configured to, in response to determining that the redundancy version segmentation is to be used, send to a user equipment (UE) an indication for indicating that the redundancy version segmentation is to be used in TTI bundling.

53. An apparatus for performing Transmission Time Interval (TTI) bundling in a Time Division Duplex (TDD) system, the apparatus comprising:
a version segmentation unit configured to segment a redundancy version of a transport block into a first part and a second part; and
a packet transmission unit configured to transmit a first TTI bundling packet containing the first part on a special subframe and a second TTI bundling packet containing the second part on another special subframe.

54. The apparatus according to claim 53, wherein the first part of the redundancy version is one half of the redundancy version and the second part of the redundancy version is the other half of the redundancy version.

55. The apparatus according to claim 53, further comprising:
an arrangement determination unit configured to determine an arrangement of subframes for the TTI bundling; and
a sequence setting unit configured to set a sequence of redundancy versions used in the TTI bundling according to the arrangement of subframes,
wherein the redundancy version of the transport block is redundancy version 3.

56. The apparatus according to claim 53, wherein each of the special subframe and the another special subframe comprises a first portion for downlink transmission, a second portion for guard period, and a third portion for uplink transmission, and wherein lengths of the first portion, the second portion and the third portion are set so that that transition time between the downlink transmission and the uplink transmission is substantially consistent with that for a special subframe of a legacy UE.

57. The apparatus according to claim 56, wherein the first portion, the second portion and the third portion have a length ratio of 6:3:5, and wherein the ratio of the number of resource blocks allocated to each of the special subframe and the another special subframe to the number of resource blocks allocated to a normal subframe is 4:3.

58. The apparatus according to claim 53, further comprising:
an indication receiving unit configured to receive an indication for indicating that the redundancy version segmentation is to be used in TTI bundling;
wherein the version segmentation unit and the packet transmission unit are configured to operate in response to receiving the indication.
